(19) United States
(12) Patent Application Publication
(10) Pub. No.: US 2022/0417961 A1
(43) Pub. Date: Dec. 29, 2022

(54) SIDELINK SS/PSBCH BLOCK STRUCTURE FOR UNLICENSED OPERATION

(71) Applicant: Samsung Electronics Co., Ltd., Suwon-si (KR)

(72) Inventor: Hongbo Si, Plano, TX (US)

(21) Appl. No.: 17/805,856

(22) Filed: Jun. 7, 2022

Related U.S. Application Data
(60) Provisional application No. 63/214,042, filed on Jun. 23, 2021.
(60) Provisional application No. 63/320,971, filed on Mar. 17, 2022.

(51) Int. Cl. H04W 72/12; H04W 56/00; H04L 27/26

(52) U.S. Cl. CPC H04W 72/1263; H04W 56/001; H04L 27/26025; H04W 92/18

(57) ABSTRACT

Methods and apparatuses for a sidelink synchronization signals and physical sidelink broadcast channel block (S-SS/PSBCH) block structure for unlicensed operation. A method of a user equipment (UE) in a wireless communication system includes determining a subcarrier spacing (SCS) of a sidelink synchronization signals and physical sidelink broadcast channel (S-SS/PSBCH) block; determining a set of interlaced resource blocks (RBs). The set of interlaced RBs includes RBs with a uniform interval k. The method further includes mapping the S-SS/PSBCH block to the set of interlaced RBs and transmitting, to another UE, the S-SS/PSBCH block over a sidelink channel.

### CROSS-REFERENCE TO RELATED APPLICATIONS AND CLAIM OF PRIORITY

The present application claims priority to U.S. Provisional Patent Application No. 63/214,042, filed on Jun. 23, 2021, and U.S. Provisional Patent Application No. 63/320,971, filed on Mar. 17, 2022. The content of the above-identified patent documents is incorporated herein by reference.

### TECHNICAL FIELD

The present disclosure relates generally to wireless communication systems and, more specifically, the present disclosure relates to a sidelink synchronization signals and physical sidelink broadcast channel block (S-SS/PSBCH) block structure for unlicensed operation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a sidelink SS/PSBCH block structure for unlicensed operation in a wireless communication system.

In one embodiment, a user equipment (UE) in a wireless communication system is provided. The UE including a processor configured to: determine a subcarrier spacing (SCS) of a S-SS/PSBCH block; determine a set of interlaced resource blocks (RBs); and map the S-SS/PSBCH block to the set of interlaced RBs. The set of interlaced RBs includes RBs with a uniform interval k. A transceiver operably coupled to the processor. The transceiver configured to transmit, to another UE, the S-SS/PSBCH block over a sidelink channel.

In another embodiment, a method of a UE in a wireless communication system is provided. The method includes determining a SCS of a S-SS/PSBCH block; determining a set of interlaced RBs. The set of interlaced RBs includes RBs with a uniform interval k. The method further includes mapping the S-SS/PSBCH block to the set of interlaced RBs and transmitting, to another UE, the S-SS/PSBCH block over a sidelink channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of structure of S-SS/PSBCH block according to embodiments of the present disclosure;

FIG. 7A illustrates another example of structure of S-SS/PSBCH block according to embodiments of the present disclosure;

FIG. 7B illustrates yet another example of structure of S-SS/PSBCH block according to embodiments of the present disclosure;

FIG. 7C illustrates yet another example of structure of S-SS/PSBCH block according to embodiments of the present disclosure;

FIG. 8 illustrates yet another example of structure of S-SS/PSBCH block according to embodiments of the present disclosure;

FIG. 9 illustrates an example of two S-SS/PSBCHs at the edges of a channel according to embodiments of the present disclosure;

FIG. 10 illustrates an example of at least two S-SS/PSBCHs within a channel according to embodiments of the present disclosure;

FIG. 11A illustrates an example of new structure of S-SS/PSBCH block according to embodiments of the present disclosure;

FIG. 11B illustrates an example of new structure of S-SS/PSBCH block according to embodiments of the present disclosure;

FIG. 11C illustrates an example of new structure of S-SS/PSBCH block according to embodiments of the present disclosure; and

FIG. 12 illustrates an example of a method for operating with a SS/PSBCH block structure for SL communication according to embodiments of the present disclosure.

### DETAILED DESCRIPTION

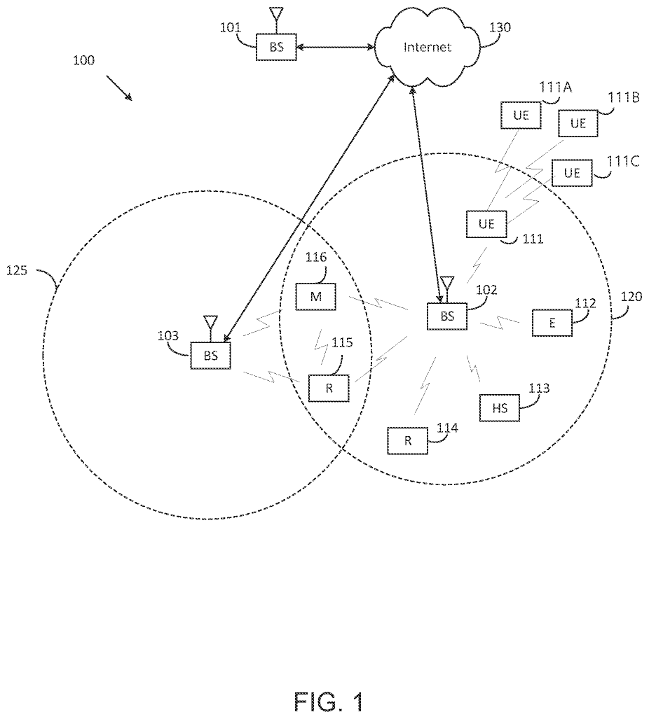

FIG. 1 through FIG. 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; and 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a channel access procedure for sidelink SS/PSBCH block structure for unlicensed operation in a wireless communication system. In certain embodiments, and one or more of the gNBs 101-103 includes circuitry, programing, or a combination thereof, for a channel access procedure for sidelink SS/PSBCH block structure for unlicensed operation in a wireless communication system.

As discussed in greater detail below, the wireless network 100 may have communications facilitated via one or more devices (e.g., UE 111A to 111C) that may have a SL communication with the UE 111. The UE 111 can communicate directly with the UEs 111A to 111C through a set of SLs (e.g., SL interfaces) to provide sideline communication, for example, in situations where the SBs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with SBs 111A to 111C with or without support by the BS 102. Various of the UEs (e.g., as depicted by UEs 112 to 116) may be capable of one or more communication with their other UEs (such as UEs 111A to 111C as for UE 111).

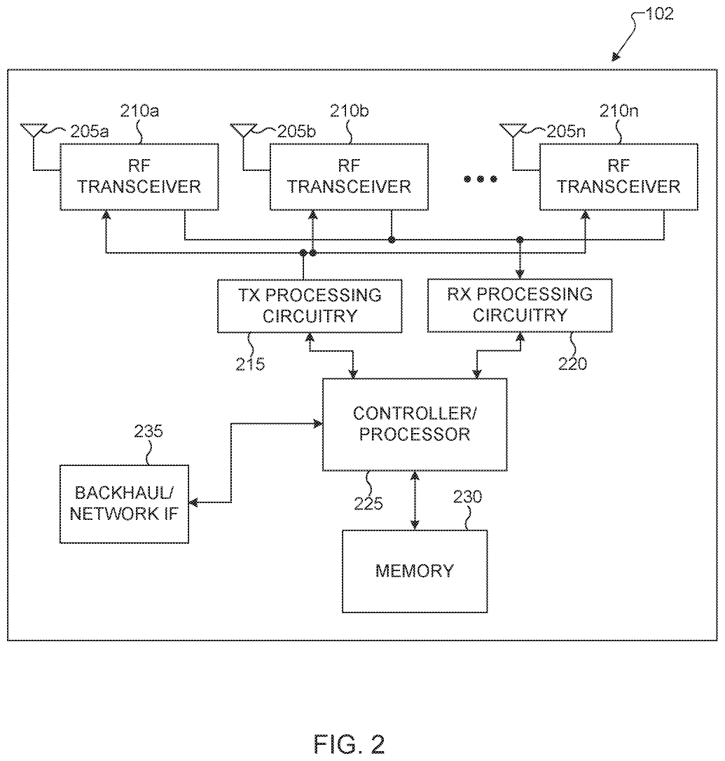

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support a sidelink SS/PSBCH block structure for unlicensed operation in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

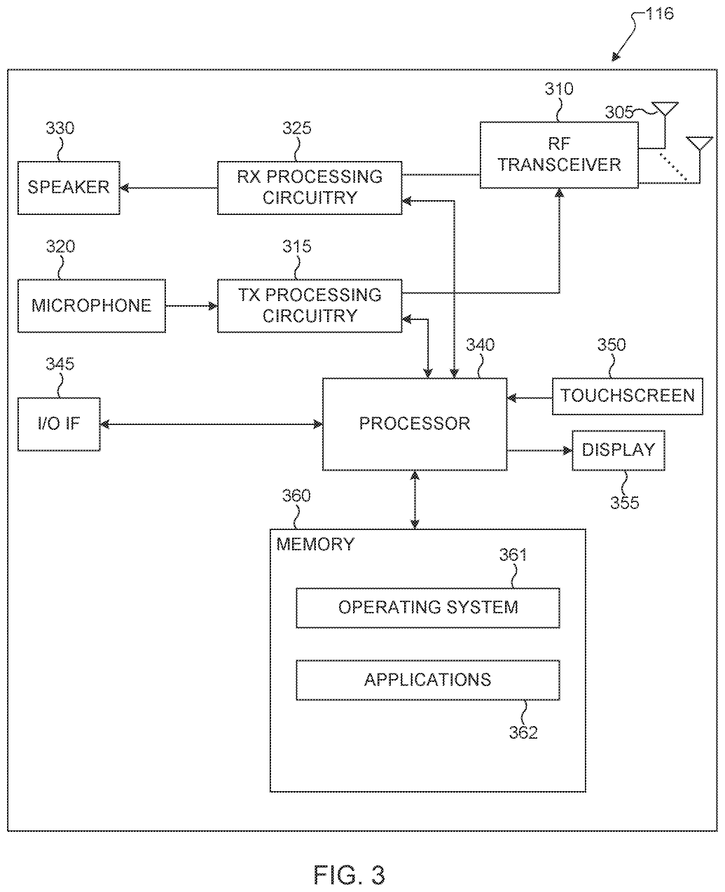

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and RX processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a sidelink SS/PSBCH block structure for unlicensed operation in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

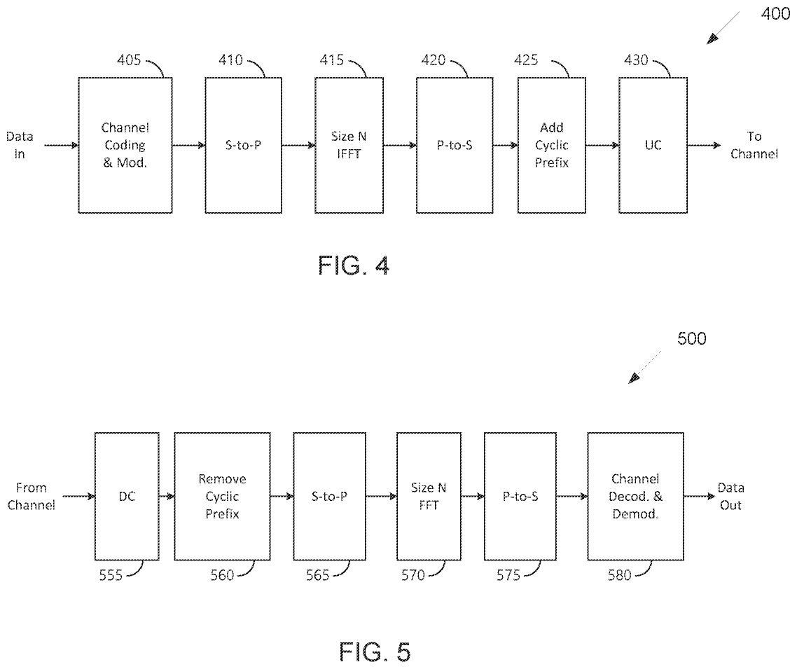

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

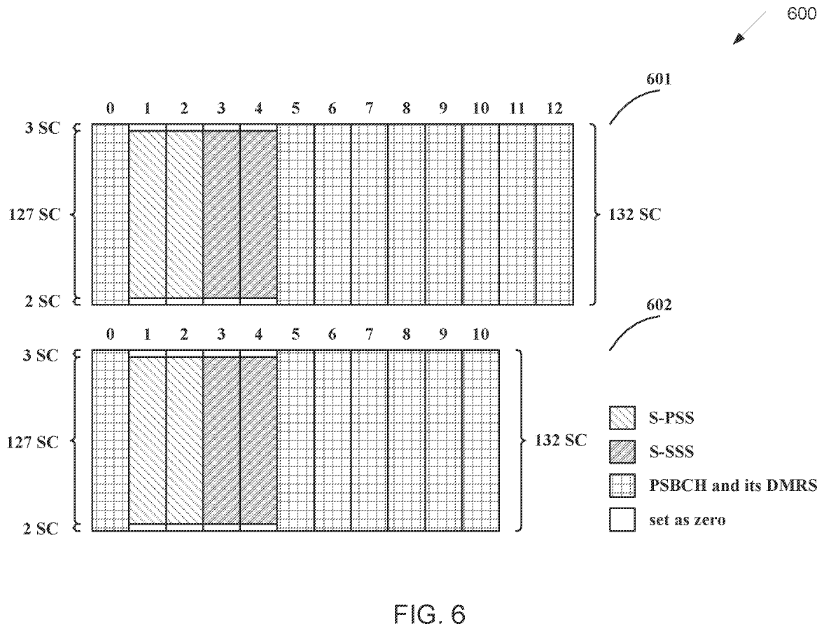

FIG. 6 illustrates an example of structure of S-SS/PSBCH block 600 according to embodiments of the present disclosure. An embodiment of the structure of S-SS/PSBCH block 600 shown in FIG. 6 is for illustration only.

In NR sidelink, sidelink synchronization signals and physical sidelink broadcast channel block (S-SS/PSBCH block or S-SSB) is supported, wherein the subcarrier spacing (SCS) of the S-SS/PSBCH block is provided by a pre-configuration or a higher layer parameter. As shown in FIG. 6, one S-SS/PSBCH block includes 132 contiguous subcarriers (SC) in frequency domain and 14 contiguous symbols for normal CP or 12 contiguous symbols for extended CP in time domain. Within a S-SS/PSBCH block, sidelink primary synchronization signal (S-PSS) is mapped to symbol #1 and #2, and sidelink secondary synchronization signal (S-SSS) is mapped to symbol #3 and #4, wherein subcarriers with index 2 to 128 (127 subcarriers in total) are mapped for S-PSS or S-SSS in frequency domain, while subcarriers with indexes 0, 1, 129, 130, and 131 are set as zero. PSBCH is mapped to symbol #0 and #5 to #N_{symb}^{S-SSB}−1, with DM-RS for PSBCH multiplexed in the symbols, wherein N_{symb}^{S-SSB}=13 for normal CP and N_{symb}^{S-SSB}=11 for extended CP. A summary of the mapping in time and frequency domain is shown in TABLE 1.

TABLE 1
Resource mapping within a S-SS/PSBCH block.

| Signal or channel | Symbol index | Subcarrier index |
|---|---|---|
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, 131 |
| PSBCH | 0, 5, 6, . . . , | 0, 1, . . . , 130, 131 |
| | N_{symb}^{S-SSB} − 1 | |
| DM-RS for PSBCH | 0, 5, 6, . . . , | 0, 4, . . . , 124, 128 |
| | N_{symb}^{S-SSB} − 1 | |

For sidelink operated over an unlicensed spectrum, the transmission of sidelink signals and channels may be subject to the occupied channel bandwidth (OCB) requirement, due to the requirement of regulation for the unlicensed spectrum. For example, for 5 GHz unlicensed spectrum, at least 80% of the nominal channel bandwidth needs to be satisfied when transmitting.

In order to meet the OCB requirement, enhancement or modification to the S-SS/PSBCH block is needed, when the sidelink is operated over an unlicensed spectrum. This disclosure addresses such enhancement or modification to the S-SS/PSBCH block.

The present disclosure focuses on the S-SS/PSBCH structure on the unlicensed spectrum, such that the transmission of S-SS/PSBCH block can satisfy the OCB requirement of the channel on the unlicensed spectrum.

More precisely, the present disclosure includes the following components: (1) RB-level interlace based S-SS/PSBCH block structure; (2) RE-level interlaces based S-SS/PSBCH block structure; (3) Two blocks of S-SS/PSBCH block on each edge of the channel; (4) S-SS/PSBCH block repetition within the channel; and (5) New S-SS/PSBCH block structure.

In the present disclosure, notation {α₁, α₂, . . . , αₙ} refers to a sequence with increasing order, and {α₁, α₂, . . . , αₙ} refers to empty set if α₁>αₙ.

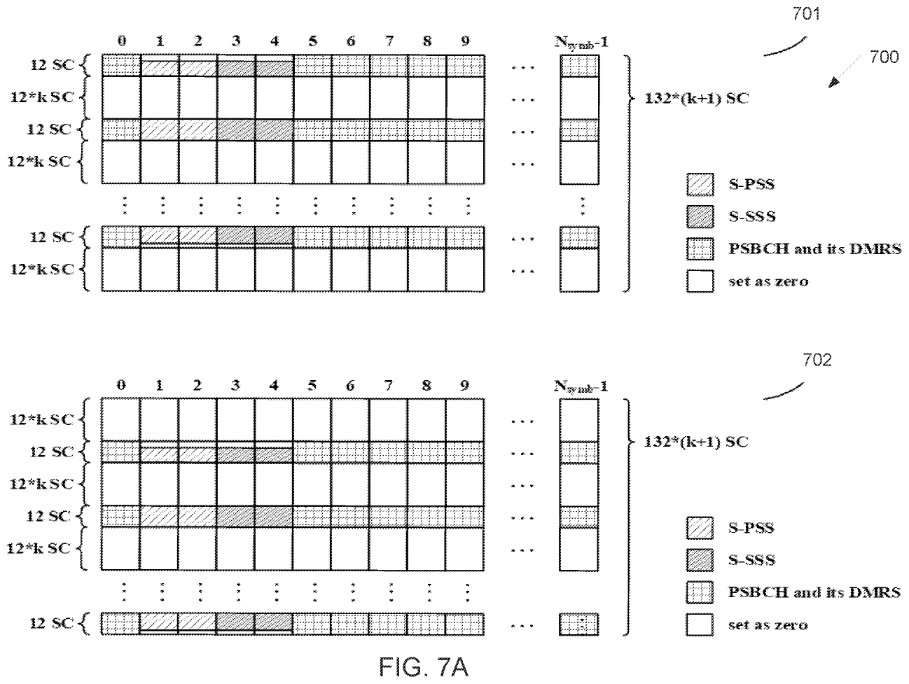

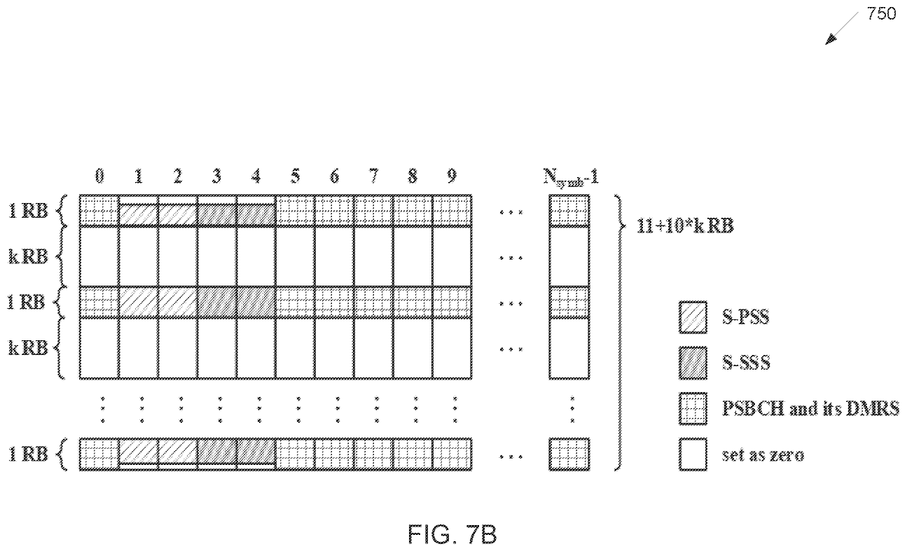

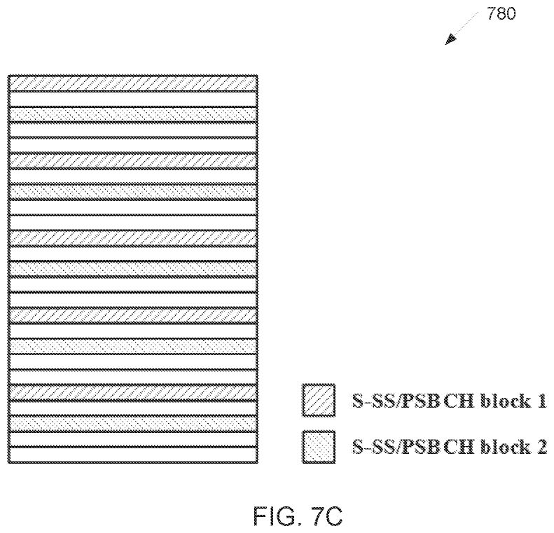

FIG. 7A illustrates another example of structure of S-SS/PSBCH block 700 according to embodiments of the present disclosure. An embodiment of the structure of S-SS/PSBCH block 700 shown in FIG. 7A is for illustration only.

In one embodiment, the 132 subcarriers within a S-SS/PSBCH block are grouped into 11 RBs (each RB has 12 subcarriers), and further interlaced with k RBs set as zero to construct a block with 132*(k+1) subcarriers in frequency domain (e.g. equivalent to mapping the S-SS/PSBCH block to a set of interlaced RBs with an uniform interval of k RBs between two neighboring RBs, such that the set of interlaced RBs includes RBs with indexes j+(k+1)·i, where j is an index of a first RB in the set of interlaced RBs, and i is the RB index within the set which is an integer starting from 0). An illustration of the structure is shown in 701 or 702 of FIG. 7A, and the corresponding resource mapping is shown in TABLE 2-1 or TABLE 2-2, respectively.

TABLE 2-1
Example resource mapping within a S-SS/PSBCH block.

| Signal or | | |
|---|---|---|
| channel | Symbol index | Subcarrier index |
| S-PSS | 1, 2 | {2, 3, . . . , 11} + 12 * k, |
| | | {0, 1, . . . , 11} + 12 * k + 12 * (k + 1) * i, i = 1, . . . , 9, |
| | | {0, 1, . . . 8} + 12 * k + 12 * (k + 1) * 10 |
| S-SSS | 3, 4 | {2, 3, . . . , 11} + 12 * k, |
| | | {0, 1, . . . , 11} + 12 * k + 12 * (k + 1) * i, i = 1, . . . , 9, |
| | | {0, 1, . . . 8} + 12 * k + 12 * (k + 1) * 10 |
| Set to zero | 1, 2, 3, 4 | {0, 1} + 12 * k, |
| | | {9, 10, 11} + 12 * k + 12 * (k + 1) * 10 |
| | 0, 1, 2, . . . , | {0, 1, . . . , 12 * k − 1} + 12 * (k + 1) * i, i = 0, 1, . . . , 10 |
| | N_{symb}^{S-SSB} − 1 | |
| PSBCH | 0, 5, 6, . . . , | {0, 1, . . . , 11} + 12 * k + 12 * (k + 1) * i, i = |
| | N_{symb}^{S-SSB} − 1 | 0, 1, . . . , 10 |
| DM-RS for | 0, 5, 6, . . . , | {0, 4, 8} + 12 * k + 12 * (k + 1) * i, i = 0, 1, . . . , 10 |
| PSBCH | N_{symb}^{S-SSB} − 1 | |

TABLE 2-2
Example resource mapping within a S-SS/PSBCH block.

| Signal or | | |
|---|---|---|
| channel | Symbol index | Subcarrier index |
| S-PSS | 1, 2 | {2, 3, . . . , 11}, |
| | | {0, 1, . . . , 11} + 12 * (k + 1) *i, i = 1, . . . , 9, |
| | | {0, 1, . . . 8} + 12 * (k + 1) * 10 |
| S-SSS | 3, 4 | {2, 3, . . . , 11}, |
| | | {0, 1, . . . , 11} + 12 * (k + 1) *i, i = 1, . . . , 9, |
| | | {0, 1, . . . 8} + 12 * (k + 1) * 10 |
| Set to zero | 1, 2, 3, 4 | 0, 1, |
| | | {9, 10, 11} + 12 * (k + 1) * 10 |
| | 0, 1, 2, . . . , | {12, 13, . . . , 12 * (k + 1) − 1} + 12 * (k + 1) * i , i = |
| | N_{symb}^{S-SSB} − 1 | 0, 1, . . . , 10 |
| PSBCH | 0, 5, 6, . . . , | {0, 1, . . . , 11} + 12 * (k + 1) * i, i = 0, 1, . . . , 10 |
| | N_{symb}^{S-SSB} − 1 | |
| DM-RS for | 0, 5, 6, . . . , | {0, 4, 8} + 12 * (k + 1) * i, i = 0, 1, . . . , 10 |
| PSBCH | N_{symb}^{S-SSB} − 1 | |

In one example, k is a fixed value. For one example, k=1. For another example, k=3. For yet another example, k=7. For yet another example, k=4. For yet another example, k=9.

In another example, k can be determined according to the subcarrier spacing (SCS) of the S-SS/PSBCH block. For one example, k=1 if the SCS of S-SS/PSBCH block is 60 kHz, and/or k=3 if the SCS of S-SS/PSBCH block is 30 kHz, and/or k=7 if the SCS of S-SS/PSBCH block is 15 kHz. For another example, k=0 if the SCS of S-SS/PSBCH block is 60 kHz, and/or k=1 if the SCS of S-SS/PSBCH block is 30 kHz, and/or k=3 if the SCS of S-SS/PSBCH block is 15 kHz. For yet another example, k=1 if the SCS of S-SS/PSBCH block is 60 kHz, and/or k=4 if the SCS of S-SS/PSBCH block is 30 kHz, and/or k=9 if the SCS of S-SS/PSBCH block is 15 kHz.

In yet another example, k can be configured by a RRC parameter. For one example, k can be configured from the set of values {0, 1, 3, 7}. For another example, k can be configured from the set of values {1, 3, 7}. For yet another example, k can be configured from the set of values {0, 1, 3}. For yet another example, k can be configured from the set or its subset of values {0, 1, 2, 3, 4, 5, 6, 7}. For yet another example, k can be configured from the set or its subset of values {0, 1, 2, 3, 4, 5, 6, 7, 8, 9}. For yet another example, k can be configured from the set or its subset of values {1, 4, 9}.

In one example, the frequency location of the RE with index 66*(k+1) within the interlace based S-SS/PSBCH block can be provided by a pre-configuration or configured by a higher layer parameter.

In another example, the index j (e.g. the index of interlace, which defines the frequency location of the interlace) is provided by a pre-configuration or configured by a higher layer parameter.

FIG. 7B illustrates yet another example of structure of S-SS/PSBCH block 750 according to embodiments of the present disclosure. An embodiment of the structure of S-SS/PSBCH block 750 shown in FIG. 7B is for illustration only.

In another embodiment, the 132 subcarriers within a S-SS/PSBCH block are grouped into 11 RBs (each RB has 12 subcarriers), and further interlaced with k RBs set as zero to construct a block, wherein every two neighboring RBs within the 11 RBs are inserted with k RBs set as zero, and the overall number of RBs of the constructed block is 11+10·k RB in frequency domain (e.g. equivalent to mapping the S-SS/PSBCH block to a set of interlaced RBs with an uniform interval of k RBs between two neighboring RBs, such that the set of interlaced RBs includes RBs with indexes j+(k+1)·i, where j is an index of a first RB in the set of interlaced RBs, and i is the RB index within the set which is an integer starting from 0). An illustration of the structure is shown in 750 of FIG. 7B, and the corresponding resource mapping is shown in TABLE 2-3.

TABLE 2-3
Example resource mapping within a S-SS/PSBCH block.

| Signal or | | |
|---|---|---|
| channel | Symbol index | Subcarrier index |
| S-PSS | 1, 2 | {2, 3, . . . , 11}, |
| | | {0, 1, . . . , 11} + 12 * (k + 1) *i, i = 1, . . . , 9, |
| | | {0, 1, . . . 8} + 12 * (k + 1) * 10 |
| S-SSS | 3, 4 | {2, 3, . . . , 11}, |
| | | {0, 1, . . . , 11} + 12 * (k + 1) *i, i = 1, . . . , 9, |
| | | {0, 1, . . . 8} + 12 * (k + 1) * 10 |
| Set to zero | 1, 2, 3, 4 | 0, 1, |
| | | {9, 10, 11} + 12 * (k + 1) * 10 |
| | 0, 1, 2, . . . , | {12, 13, . . . , 12 * (k + 1) − 1} + 12 * (k + 1) * i , i = |
| | N_{symb}^{S-SSB} − 1 | 0, 1, . . . , 9 |
| PSBCH | 0, 5, 6, . . . , | { , . . . , 11} + 12 * (k + 1) * i, i = 0, 1, . . . , 10 |
| | N_{symb}^{S-SSB} − 1 | |
| DM-RS for | 0, 5, 6, . . . , | {0, 4, 8} + 12 * (k + 1) * i, i = 0, 1, . . . , 10 |
| PSBCH | N_{symb}^{S-SSB} − 1 | |

In one example, k is a fixed value. For one example, k=1. For another example, k=3. For yet another example, k=7. For yet another example, k=4. For yet another example, k=9.

In another example, k can be determined according to the subcarrier spacing (SCS) of the S-SS/PSBCH block. For one example, k=1 if the SCS of S-SS/PSBCH block is 60 kHz, and/or k=3 if the SCS of S-SS/PSBCH block is 30 kHz, and/or k=7 if the SCS of S-SS/PSBCH block is 15 kHz. For another example, k=0 if the SCS of S-SS/PSBCH block is 60 kHz, and/or k=1 if the SCS of S-SS/PSBCH block is 30 kHz, and/or k=3 if the SCS of S-SS/PSBCH block is 15 kHz. For yet another example, k=1 if the SCS of S-SS/PSBCH block is 60 kHz, and/or k=4 if the SCS of S-SS/PSBCH block is 30 kHz, and/or k=9 if the SCS of S-SS/PSBCH block is 15 kHz.

In yet another example, k can be configured by a RRC parameter. For one example, k can be configured from the set of values {0, 1, 3, 7}. For another example, k can be configured from the set of values {1, 3, 7}. For yet another example, k can be configured from the set of values {0, 1, 3}. For yet another example, k can be configured from the set or its subset of values {0, 1, 2, 3, 4, 5, 6, 7}. For yet another example, k can be configured from the set or its subset of values {0, 1, 2, 3, 4, 5, 6, 7, 8, 9}. For yet another example, k can be configured from the set or its subset of values {1, 4, 9}.

In one example, the frequency location of the RE with index 6·(11+10·k) within the interlace based S-SS/PSBCH block can be provided by a pre-configuration or configured by a higher layer parameter.

In another example, the index j (e.g. the index of interlace, which defines the frequency location of the interlace) is provided by a pre-configuration or configured by a higher layer parameter.

In yet another example, the frequency location of the RE with index 66 of the S-SS/PSBCH block before mapped to the set of interlaced RBs can be provided by a pre-configuration or configured by a higher layer parameter.

In another example, when the number of RBs in the listen-before-talk (LBT) bandwidth (e.g., an RB-set) is sufficient, the constructed block using interlaces can be mapped into a LBT bandwidth (e.g., an RB-set) and transmitted. For one example, for k=1, when the number of RBs in the LBT bandwidth (e.g., an RB-set) is at least 21, an interlace based S-SS/PSBCH block can be transmitted in such LBT bandwidth (e.g., an RB-set). For another example, for k=4, when the number of RBs in the LBT bandwidth (e.g., an RB-set) is at least 51, an interlace based S-SS/PSBCH block can be transmitted in such LBT bandwidth (e.g., an RB-set). For yet another example, for k=9, when the number of RBs in the LBT bandwidth (e.g., an RB-set) is at least 101, an interlace based S-SS/PSBCH block can be transmitted in such LBT bandwidth (e.g., an RB-set).

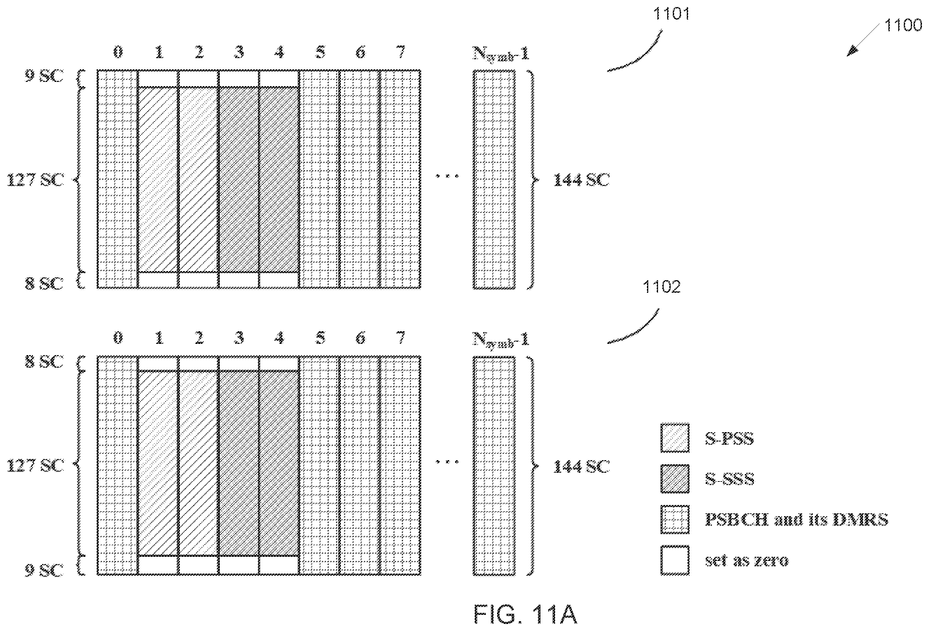

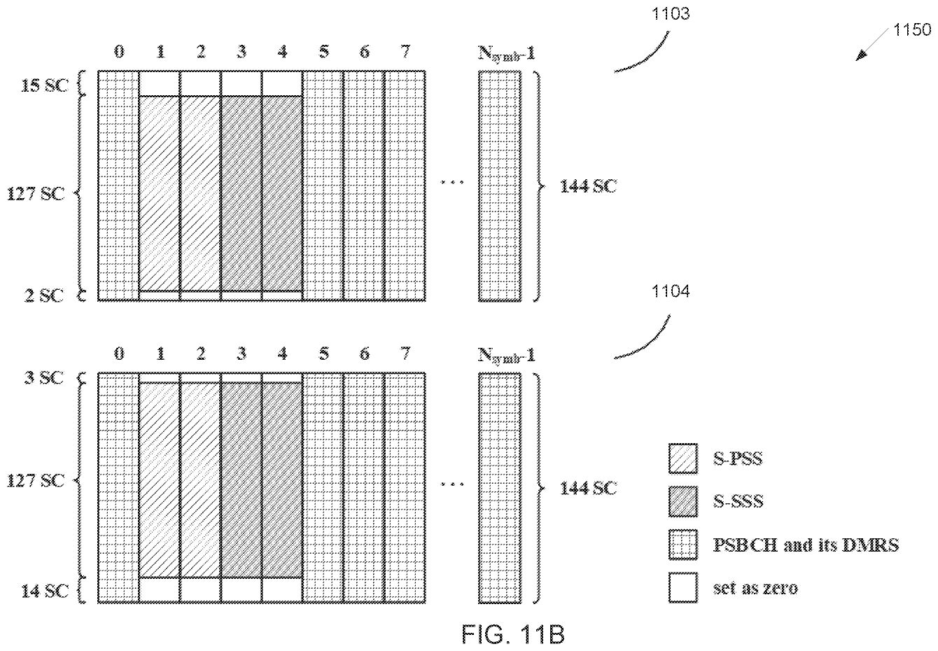

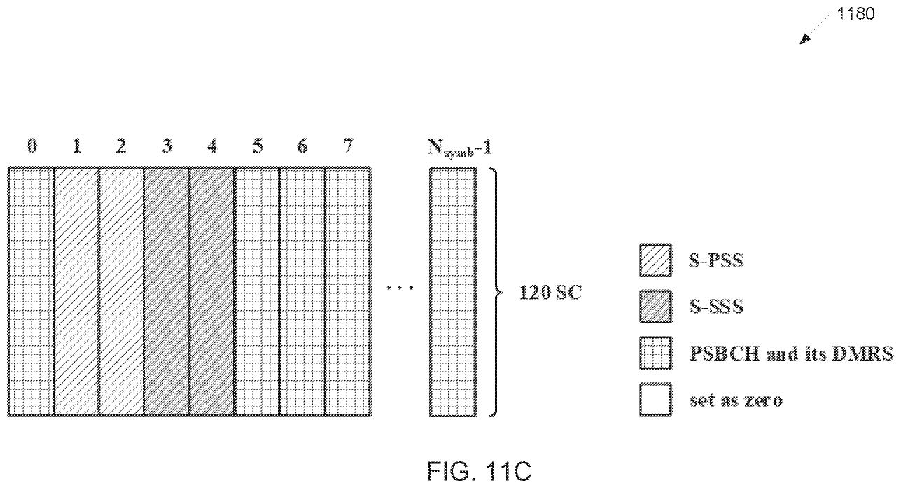

In yet another example, when the number of RBs in the LBT bandwidth (e.g., a RB-set) is not sufficient (e.g., the number of RBs in the LBT bandwidth (e.g., a RB-set) is smaller than the bandwidth of the interlace based S-SS/PSBCH block), or the number of RBs in the set of interlaced RBs is not sufficient (e.g. the number of RBs in the set of interlaced RBs is smaller than 11 RBs), the constructed block using interlaces can be truncated (e.g., truncating the lowest RB(s) to fit the LBT bandwidth and/or the highest RB(s) to fit the LBT bandwidth, or truncating the S-SS/PSBCH block into 10 RBs as illustrated in FIG. 11C and then mapped to the set of interlaced RBs), and mapped into a LBT bandwidth or the set of interlaced RBs and then transmitted. For example, for k=4, when the number of RBs in the LBT bandwidth (e.g., an RB-set) is 49 or 50, an interlace based S-SS/PSBCH block can be truncated by 2 or 1 RBs, e.g., from the lowest and/or highest RB, and fit into the LBT bandwidth. For another example, for k=4, when the number of RBs in the set of interlaced RBs is 10, the S-SS/PSBCH block can be truncated to 10 RBs (e.g. 120 subcarriers), e.g., from the lowest and/or highest RB and/or 6 subcarriers from both sides, and fit into the set of interlaced RBs.

In yet another example, when the number of RBs in the LBT bandwidth (e.g., a RB-set) is not sufficient (e.g., the number of RBs in the LBT bandwidth (e.g., a RB-set) is smaller than the bandwidth of the interlace based S-SS/PSBCH block), or the number of RBs in the set of interlaced RBs is not sufficient (e.g. the number of RBs in the set of interlaced RBs is smaller than 11 RBs), one or more of the RBs with non-zero values (e.g., the lowest RB and/or the highest RB) in the constructed block using interlaces can be shifted to fit the LBT bandwidth (e.g., effectively resulting in a non-uniform interlace based S-SS/PSBCH block with a smaller bandwidth), and mapped into a LBT bandwidth and then transmitted. For one example, for k=4, when the number of RBs in the LBT bandwidth (e.g., an RB-set) is 50, one RB with non-zero values (e.g., the lowest RB or the highest RB) in an interlace based S-SS/PSBCH block can be shifted by 1 RBs and fit into the LBT bandwidth.

For another example, for k=4, when the number of RBs in the LBT bandwidth (e.g., an RB-set) is 49, one RB with non-zero values (e.g., the lowest RB or the highest RB) in an interlace based S-SS/PSBCH block can be shifted by 2 RBs and fit into the LBT bandwidth. For yet another example, for k=4, when the number of RBs in the LBT bandwidth (e.g., an RB-set) is 49, the highest and lowest RB with non-zero values in an interlace based S-SS/PSBCH block can both be shifted (in opposite direction) by 1 RB (such that the overall bandwidth is reduced by 2 RBs) and fit into the LBT bandwidth.

In yet another example, when the number of RBs in the LBT bandwidth (e.g., an RB-set) is not sufficient (e.g., the number of RBs in the LBT bandwidth (e.g., an RB-set) is smaller than the bandwidth of the interlace based S-SS/PSBCH block), or the number of RBs in the set of interlaced RBs is not sufficient (e.g. the number of RBs in the set of interlaced RBs is smaller than 11 RBs), the constructed block using interlaces may not be allowed to be transmitted on the LBT bandwidth (e.g. may not be mapped to the set of interlaced RBs). For example, for k=4, when the number of RBs in the LBT bandwidth (e.g., an RB-set) is 49 or 50, an interlace based S-SS/PSBCH block may not be able to be transmitted on the LBT bandwidth. For another example, for k=4, when the number of RBs in the LBT bandwidth (e.g., an RB-set) is 10, an interlace based S-SS/PSBCH block may not be able to be transmitted on the LBT bandwidth.

FIG. 7C illustrates yet another example of structure of S-SS/PSBCH block 780 according to embodiments of the present disclosure. An embodiment of the structure of S-SS/PSBCH block 780 shown in FIG. 7C is for illustration only.

In yet another example, multiple interlace based S-SS/PSBCH blocks can be mapped into the same LBT bandwidth (e.g., an RB-set), wherein the resource elements for non-zero values do not overlap in the multiple interlace based S-SS/PSBCH blocks. An illustration of an example is shown in FIG. 7C.

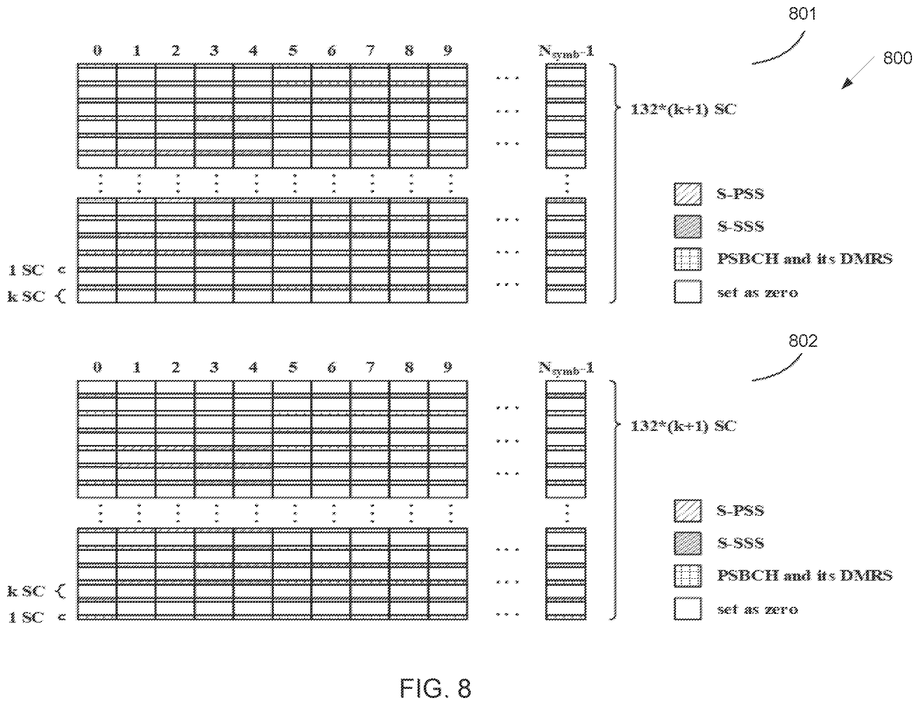

In one embodiment, each subcarrier in the 132 subcarriers within a S-SS/PSBCH block can be interlaced with k subcarriers set as zero to construct a block with 132*(k+1) subcarriers in frequency domain. An illustration of the structure is shown in 801 or 802 of FIG. 8, and the corresponding resource mapping is shown in TABLE 3-1 or TABLE 3-2, respectively.

TABLE 3-1
Example resource mapping within a S-SS/PSBCH block.

| Signal or | | |
|---|---|---|
| channel | Symbol index | Subcarrier index |
| S-PSS | 1, 2 | k + (k + 1) * i, i = 2, 3, . . . , 128 |
| S-SSS | 3, 4 | k + (k + 1) * i, i = 2, 3, . . . , 128 |
| Set to zero | 1, 2, 3, 4 | k + (k + 1) * i, i = 0, 1, 129, |
| | | 130, 131 |
| | 0, 1, 2, . . . , | {0, . . . , k − 1} + (k + |
| | N_{symb}^{S-SSB} − 1 | 1) * i, i = 0, 1, . . . , 131 |
| PSBCH | 0, 5, 6, . . . , | k + (k + 1) * i, i = 0, 1, |
| | N_{symb}^{S-SSB} − 1 | . . . , 131 |
| DM-RS for | 0, 5, 6, . . . , | k + 4 * (k + 1) * i, i = 0, |
| PSBCH | N_{symb}^{S-SSB} − 1 | 1, . . . , 32 |

TABLE 3-2
Example resource mapping within a S-SS/PSBCH block.

| Signal or | | |
|---|---|---|
| channel | Symbol index | Subcarrier index |
| S-PSS | 1, 2 | (k + 1) * i, i = 2, 3, . . . , 128 |
| S-SSS | 3, 4 | (k + 1) * i, i = 2, 3, . . . , 128 |
| Set to zero | 1, 2, 3, 4 | (k + 1) * i, i = 0, 1, 129, 130, |
| | | 131 |
| | 0, 1, 2, . . . , | {1, . . . , k} + (k + 1) * |
| | N_{symb}^{S-SSB} − 1 | i, i = 0, 1, . . . , 131 |
| PSBCH | 0, 5, 6, . . . , | (k + 1) * i, i = 0, 1, . . . , 131 |
| | N_{symb}^{S-SSB} − 1 | |
| DM-RS for | 0, 5, 6, . . . , | 4 * (k + 1) * i, i = 0, 1, |
| PSBCH | N_{symb}^{S-SSB} − 1 | . . . , 32 |

In one example, k is a fixed value. For one example, k=1. For another example, k=3. For yet another example, k=7. For yet another example, k=4. For yet another example, k=9.

In another example, k can be determined according to the subcarrier spacing (SCS) of the S-SS/PSBCH block. For one example, k=1 if the SCS of S-SS/PSBCH block is 60 kHz, and/or k=3 if the SCS of S-SS/PSBCH block is 30 kHz, and/or k=7 if the SCS of S-SS/PSBCH block is 15 kHz. For another example, k=0 if the SCS of S-SS/PSBCH block is 60 kHz, and/or k=1 if the SCS of S-SS/PSBCH block is 30 kHz, and/or k=3 if the SCS of S-SS/PSBCH block is 15 kHz. For yet another example, k=1 if the SCS of S-SS/PSBCH block is 60 kHz, and/or k=4 if the SCS of S-SS/PSBCH block is 30 kHz, and/or k=9 if the SCS of S-SS/PSBCH block is 15 kHz.

In yet another example, k can be configured by a RRC parameter. For one example, k can be configured from the set of values {0, 1, 3, 7}. For another example, k can be configured from the set of values {1, 3, 7}. For yet another example, k can be configured from the set of values {0, 1, 3}. For yet another example, k can be configured from the set or its subset of values {0, 1, 2, 3, 4, 5, 6, 7}. For yet another example, k can be configured from the set or its subset of values {0, 1, 2, 3, 4, 5, 6, 7, 8, 9}. For yet another example, k can be configured from the set or its subset of values {1, 4, 9}.

In one embodiment, each subcarrier in the 132 subcarriers within a S-SS/PSBCH block can be interlaced with k subcarriers set as zero to construct a block, wherein every two neighboring subcarriers within the 132 subcarriers are inserted with k subcarriers set as zero, and the overall number of subcarriers is 132+131*k subcarriers in frequency domain. The corresponding resource mapping is shown in TABLE 3-3.

TABLE 3-3
Example resource mapping within a S-SS/PSBCH block.

| Signal or | | |
|---|---|---|
| channel | Symbol index | Subcarrier index |
| S-PSS | 1, 2 | (k + 1) * i, i = 2, 3, . . . , 128 |
| S-SSS | 3, 4 | (k + 1) * i, i = 2, 3, . . . , 128 |
| Set to zero | 1, 2, 3, 4 | (k + 1) * i, i = 0, 1, 129, 130 |
| | 0, 1, 2, . . . , | {1, . . . , k} + (k + 1) * i, |
| | N_{symb}^{S-SSB} − 1 | i = 0, 1, . . . , 130 |
| PSBCH | 0, 5, 6, . . . , | (k + 1) * i, i = 0, 1, . . . , 131 |
| | N_{symb}^{S-SSB} − 1 | |
| DM-RS for | 0, 5, 6, . . . , | 4 * (k + 1) * i, i = 0, 1, . . . , 32 |
| PSBCH | N_{symb}^{S-SSB} − 1 | |

In one example, the constructed block using interlaces can be mapped into a LBT bandwidth (e.g., an RB-set) and transmitted, only when the number of REs in the LBT bandwidth (e.g., an RB-set) is sufficient.

In another example, multiple interlace based S-SS/PSBCH blocks can be mapped into the same LBT bandwidth (e.g., an RB-set), wherein the REs for non-zero values do not overlap in the multiple interlace based S-SS/PSBCH blocks.

FIG. 8 illustrates yet another example of structure of S-SS/PSBCH block 800 according to embodiments of the present disclosure. An embodiment of the structure of S-SS/PSBCH block 800 shown in FIG. 8 is for illustration only.

In one embodiment, when a single S-SS/PSBCH block cannot satisfy the OCB requirement of a channel bandwidth, there can be two FDMed S-SS/PSBCH blocks allocated within a channel bandwidth, with a potential gap in the middle, wherein each of the S-SS/PSBCH block has the same structure as in FIG. 6 or FIG. 11 (a, b, or c). One first S-SS/PSBCH block is allocated on the top of the channel (e.g., with its highest subcarrier aligned with or close to the highest subcarrier of the channel, not counting the guard band), and one second S-SS/PSBCH block is allocated on the bottom of the channel (e.g., with its lowest subcarrier aligned with or close to the lowest subcarrier of the channel, not counting the guard band). The overall bandwidth of the two S-SS/PSBCH blocks (e.g., from the lowest subcarrier of the second S-SS/PSBCH block to the highest subcarrier of the first S-SS/PSBCH block) can satisfy the OCB requirement of the channel bandwidth.

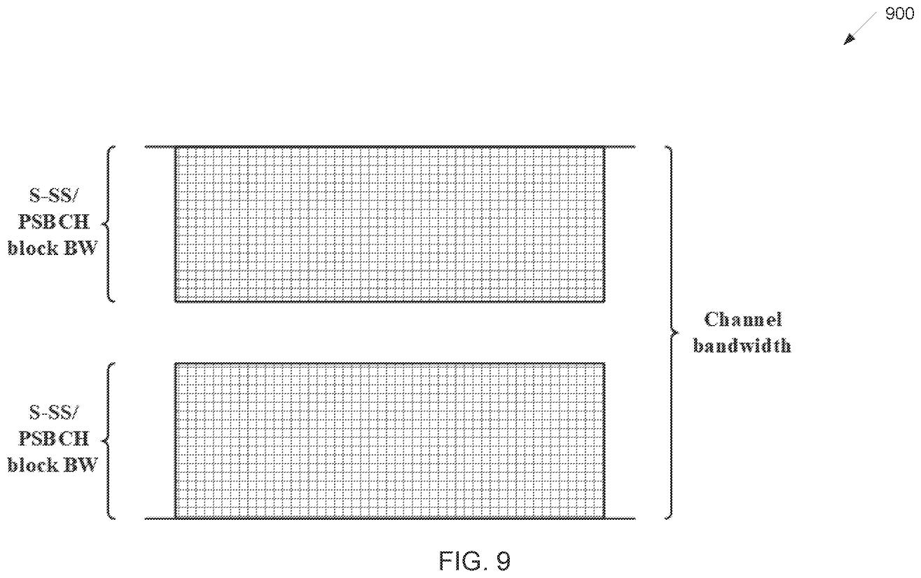

FIG. 9 illustrates an example of two S-SS/PSBCHs at the edges of a channel 900 according to embodiments of the present disclosure. An embodiment of the two S-SS/PSBCHs at the edges of a channel 900 shown in FIG. 9 is for illustration only.

In one example, the time domain pattern of the two S-SS/PSBCH blocks within a channel can be the same, wherein the time domain pattern can include at least one of a number of S-SS/PSBCH blocks within a period (e.g., sl-NumSSB-WithinPeriod), a slot offset for the first slot including S-SS/PSBCH block (e.g., sl-TimeOffsetSSB), or a slot interval between two neighboring S-SS/PSBCH blocks (e.g., sl-TimeInterval).

In another example, the frequency locations of the two S-SS/PSBCH blocks are indicated separately, e.g., using sl-AbsoluteFrequencySSB for each S-SS/PSBCH block. In one further example, there can be a restriction on the frequency location configurations of the two S-SS/PSBCH blocks (e.g., sl-AbsoluteFrequencySSB) such that OCB requirement is satisfied, e.g., the first S-SS/PSBCH block is allocated on the top of the channel with its highest subcarrier aligned with the highest subcarrier of the channel (e.g., not counting the guard band), and the second S-SS/PSBCH block is allocated on the bottom of the channel with its lowest subcarrier aligned with the lowest subcarrier of the channel (e.g., not counting the guard band).

In yet another example, the physical-layer sidelink synchronization identities for the two S-SS/PSBCH blocks are identical.

In yet another example, the S-PSS symbol, S-SSS symbol, and PSBCH symbol within the two S-SS/PSBCH blocks have the same transmission power.

In yet another example, the S-SS/PSBCH block indexes of the two S-SS/PSBCH block are identical.

In yet another example, the numerology of the two S-SS/PSBCH block are the same.

In yet another example, the subcarrier with index 0 in each of the S-SS/PSBCH blocks is aligned with a subcarrier with index 0 in an RB of the SL BWP.

In one embodiment, when a single S-SS/PSBCH block cannot satisfy the OCB requirement of a channel bandwidth, there can be at least two FDMed S-SS/PSBCH blocks allocated within a channel bandwidth, with potential gap(s) between neighboring S-SS/PSBCH blocks, wherein each of the S-SS/PSBCH block has the same structure as in FIG. 6 or FIG. 11 (a, b, or c). The overall bandwidth of the at least two S-SS/PSBCH blocks (e.g., from the lowest subcarrier of the lowest S-SS/PSBCH block to the highest subcarrier of the highest S-SS/PSBCH block) can satisfy the OCB requirement of the channel bandwidth.

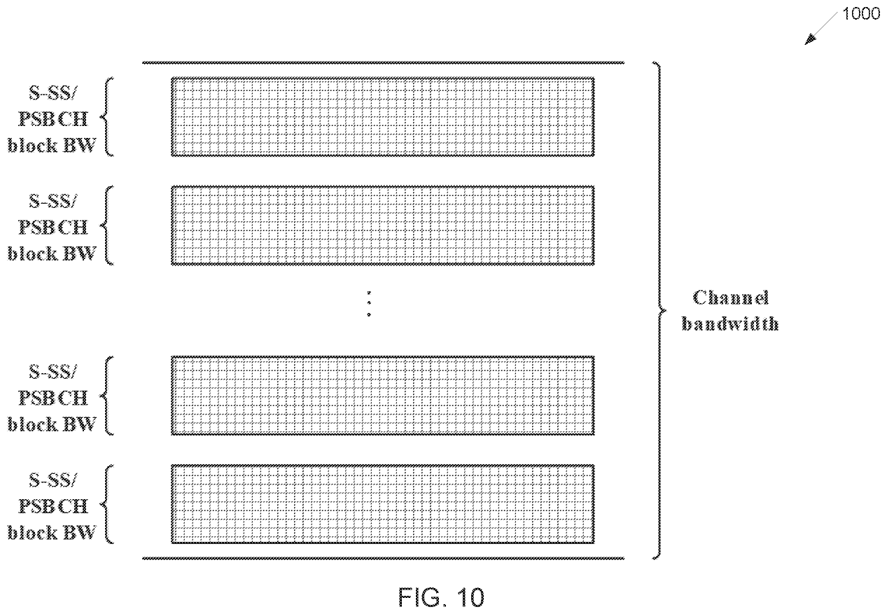

FIG. 10 illustrates an example of at least two S-SS/PSBCHs within a channel 1000 according to embodiments of the present disclosure. An embodiment of the at least two S-SS/PSBCHs within a channel 1000 shown in FIG. 10 is for illustration only.

In one example, the time domain pattern of the at least two S-SS/PSBCH blocks within a channel can be the same, wherein the time domain pattern can include at least one of a number of S-SS/PSBCH blocks within a period (e.g., sl-NumSSB-WithinPeriod), a slot offset for the first slot including S-SS/PSBCH block (e.g., sl-TimeOffsetSSB), or a slot interval between two neighboring S-SS/PSBCH blocks (e.g., sl-TimeInterval).

In another example, the frequency locations of the at least two S-SS/PSBCH blocks are indicated separately, e.g., using sl-AbsoluteFrequencySSB for each S-SS/PSBCH block. In one further example, there can be a restriction on the frequency location configurations of the two S-SS/PSBCH blocks (e.g., sl-AbsoluteFrequencySSB) such that OCB requirement is satisfied.

In yet another example, the physical-layer sidelink synchronization identities for the at least two S-SS/PSBCH blocks are identical.

In yet another example, the S-PSS symbol, S-SSS symbol, and PSBCH symbol within the at least two S-SS/PSBCH blocks have the same transmission power.

In yet another example, the S-SS/PSBCH block indexes of the at least two S-SS/PSBCH block are identical.

In yet another example, the numerology of the at least two S-SS/PSBCH block are the same.

In yet another example, the subcarrier with index 0 in each of the S-SS/PSBCH blocks is aligned with a subcarrier with index 0 in an RB of the SL BWP.

In yet another example, the size of gap between neighboring S-SS/PSBCH blocks in frequency domain can be fixed. For one example, the size of the gap can be fixed as zero. For another example, the size of the gap can be fixed as 1 RB. For yet another example, the size of the gap can be fixed as 2 RBs.

In yet another example, the size of gap between neighboring S-SS/PSBCH blocks in frequency domain can be fixed and determined based on the SCS of the S-SS/PSBCH block. For one example, the size of the gap can be fixed as 1 or 2 RB if the SCS of the S-SS/PSBCH block is 60 kHz; and/or the size of the gap can be fixed as 1 or 2 RB if the SCS of the S-SS/PSBCH block is 30 kHz; and/or the size of the gap can be fixed as 1 or 2 RB if the SCS of the S-SS/PSBCH block is 15 kHz.

In yet another example, the size of gap between neighboring S-SS/PSBCH blocks in frequency domain can be identical and configured by the same RRC parameter. For one example, the size of the gap can be identical and configured as one of the values from a set or its subset as {0, 1, 2} RBs. For another example, the size of the gap can be identical and configured from a set or its subset as {1, 2} RBs.

In yet another example, there is no explicit requirement on the size of gap between neighboring S-SS/PSBCH blocks in frequency domain, and the size of gap between different neighboring S-SS/PSBCH blocks can be not identical. The size of the gap can be determined by the UE based on the configured frequency location of S-SS/PSBCH blocks (e.g., sl-AbsoluteFrequencySSB), wherein the frequency locations may be configured such that the overall bandwidth of the at least two S-SS/PSBCH blocks (e.g., from the lowest subcarrier of the lowest S-SS/PSBCH block to the highest subcarrier of the highest S-SS/PSBCH block) can satisfy the OCB requirement of the channel bandwidth.

In one embodiment, the S-SS/PSBCH block for unlicensed spectrum is constructed based on a new block structure of S-SS/PSBCH block.

FIG. 11A illustrates an example of new structure of S-SS/PSBCH block 1100 according to embodiments of the present disclosure. An embodiment of the new structure of S-SS/PSBCH block 1100 shown in FIG. 11A is for illustration only.

For one example, an illustration of the new S-SS/PSBCH block structure is shown in 1101 or 1102 of FIG. 11A, wherein the S-SS/PSBCH block has 144 subcarriers in frequency domain, and its corresponding resource mapping is shown in TABLE 4-1 and TABLE 4-2, respectively.

TABLE 4-1
Resource mapping within the new S-SS/PSBCH block structure.

| Signal or | | |
|---|---|---|
| channel | Symbol index | Subcarrier index |
| S-PSS | 1, 2 | 8, 9, . . . , 133, 134 |
| S-SSS | 3, 4 | 8, 9, . . . , 133, 134 |
| Set to zero | 1, 2, 3, 4 | 0, 1, . . . , 7, 135, 136, . . . , 143 |
| PSBCH | 0, 5, 6, . . . , | 0, 1, . . . , 142, 143 |
| | N_{symb}^{S-SSB} − 1 | |
| DM-RS for | 0, 5, 6, . . . , | 0, 4, . . . , 136, 140 |
| PSBCH | N_{symb}^{S-SSB} − 1 | |

TABLE 4-2
Resource mapping within the new S-SS/PSBCH block structure.

| Signal or | | |
|---|---|---|
| channel | Symbol index | Subcarrier index |
| S-PSS | 1, 2 | 9, 10, . . . , 134, 135 |
| S-SSS | 3, 4 | 9, 10, . . . , 134, 135 |
| Set to zero | 1, 2, 3, 4 | 0, 1, . . . , 8, 136, 137, . . . , 143 |
| PSBCH | 0, 5, 6, . . . , | 0, 1, . . . , 142, 143 |
| | N_{symb}^{S-SSB} − 1 | |
| DM-RS for | 0, 5, 6, . . . , | 0, 4, . . . , 136, 140 |
| PSBCH | N_{symb}^{S-SSB} − 11 | |

FIG. 11B illustrates an example of new structure of S-SS/PSBCH block 1150 according to embodiments of the present disclosure. An embodiment of the new structure of S-SS/PSBCH block 1150 shown in FIG. 11B is for illustration only.

For another example, an illustration of the new S-SS/PSBCH block structure is shown in 1103 or 1104 of FIG. 11B, wherein the S-SS/PSBCH block has 144 subcarriers in frequency domain, and its corresponding resource mapping is shown in TABLE 4-3 and TABLE 4-4, respectively.

TABLE 4-3
Resource mapping within the new S-SS/PSBCH block structure.

| Signal or channel | Symbol index | Subcarrier index |
|---|---|---|
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, . . . , |
| | | 143 |
| PSBCH | 0, 5, 6, . . . , N_{symb}^{S-SSB} − 1 | 0, 1, . . . , 142, 143 |
| DM-RS for PSBCH | 0, 5, 6, . . . , N_{symb}^{S-SSB} − 1 | 0, 4, . . . , 136, 140 |

TABLE 4-4
Resource mapping within the new S-SS/PSBCH block structure.

| Signal or | | |
|---|---|---|
| channel | Symbol index | Subcarrier index |
| S-PSS | 1, 2 | 14, 15, . . . , 139, 140 |
| S-SSS | 3, 4 | 14, 15, . . . , 139, 140 |
| Set to zero | 1, 2, 3, 4 | 0, 1, . . . , 12, 13, 141, |
| | | 142, 143 |
| PSBCH | 0, 5, 6, . . . , N_{symb}^{S-SSB} − 1 | 0, 1, . . . , 142, 143 |
| DM-RS for | 0, 5, 6, . . . , N_{symb}^{S-SSB} − 1 | 0, 4, . . . , 136, 140 |
| PSBCH | | |

For another example, an illustration of the new S-SS/PSBCH block structure is shown in 1180 of FIG. 11C, wherein the S-SS/PSBCH block has 120 subcarriers in frequency domain, and its corresponding resource mapping is shown in TABLE 4-5. In one instance, the new S-SS/PSBCH block with 120 subcarriers can be determined based on truncating subcarriers from the legacy S-SS/PSBCH block with 132 subcarriers, e.g. by truncating N_{low}, lowest subcarriers and N_{high} highest subcarriers, wherein N_{low}+N_{high}=12. For one sub-instance, N_{low}=0 and, N_{high}=12. For another sub-instance, N_{low}=12 and, N_{high}=0. For yet another sub-instance, N_{low}=6 and, N_{high}=6. For yet another sub-instance, N_{low}=2 and, N_{high}=10. For yet another sub-instance, N_{low}=3 and, N_{high}=9.

TABLE 4-5
Resource mapping within the new S-SS/PSBCH block structure.

| Signal or channel | Symbol index | Subcarrier index |
|---|---|---|
| S-PSS | 1, 2 | 0, 1, . . . , 118, 119 |
| S-SSS | 3, 4 | 0, 1, . . . , 118, 119 |
| PSBCH | 0, 5, 6, . . . , N_{symb}^{S-SSB} − 1 | 0, 1, . . . , 118, 119 |
| DM-RS for PSBCH | 0, 5, 6, . . . , N_{symb}^{S-SSB} − 1 | 0, 4, . . . , 112, 116 |

In one example, the examples of this embodiment could only be applicable to some numerologies. For one instance, some examples of this embodiment could be applicable to 60 kHz subcarrier. For another instance, some examples of this embodiment could be applicable to 30 kHz subcarrier. For yet another instance, some examples of this embodiment could be applicable to 15 kHz subcarrier.

In one sub-embodiment, the 144 subcarriers within the new S-SS/PSBCH block structure are grouped into 12 RBs (each RB has 12 subcarriers), and further interlaced with k RBs set as zero to construct a block with 144*(k+1) subcarriers in frequency domain (e.g. equivalent to mapping the S-SS/PSBCH block to a set of interlaced RBs with an uniform interval of k RBs between two neighboring RBs, such that the set of interlaced RBs includes RBs with indexes j+(k+1)·i, where j is an index of a first RB in the set of interlaced RBs, and i is the RB index within the set which is an integer starting from 0). An illustration of the structure is shown in 701 or 702 of FIG. 7. The example resource mapping is shown in TABLE 5-1, TABLE 5-2, TABLE 5-3, or TABLE 5-4.

TABLE 5-1
Example resource mapping within a S-SS/PSBCH block.

| Signal or | Symbol | |
|---|---|---|
| channel | index | Subcarrier index |
| S-PSS | 1, 2 | {8, 9, 10, 11} + 12 * k, |
| | | {0, 1, . . . , 11} + 12 * k + 12 * (k + 1) * |
| | | i, i = 1, . . . , 10, |
| | | {0, 1, 2} + 12 * k + 12 * (k + 1) * 11 |
| S-SSS | 3, 4 | {8, 9, 10, 11} + 12 * k, |
| | | {0, 1, . . . , 11} + 12 * k + 12 * (k + 1) * |
| | | i, i = 1, . . . , 10, |
| | | {0, 1, 2} + 12 * k + 12 * (k + 1) * 11 |
| Set to zero | 1, 2, 3, 4 | {0, 1, . . . , 7} + 12 * k, |
| | | {3, 4, . . . , 11} + 12 * k + 12 * (k + 1) * |
| | | 11 |
| | 0, 1, 2, . . . , | {0, 1, . . . , 12 * k − 1} + 12 * (k + 1) * |
| | N_{symb}^{S-SSB} − 1 | i, i = 0, 1, . . . , 11 |
| PSBCH | 0, 5, 6, . . . , | {0, 1, . . . , 11} + 12 * k + 12 * (k + 1) * |
| | N_{symb}^{S-SSB} − 1 | i, i = 0, 1, . . . , 11 |
| DM-RS for | 0, 5, 6, . . . , | {0, 4, 8} + 12 * k + 12 * (k + 1) * i, |
| PSBCH | N_{symb}^{S-SSB} − 1 | i = 0, 1, . . . , 11 |

TABLE 5-2
Example resource mapping within a S-SS/PSBCH block.

| Signal or | Symbol | |
|---|---|---|
| channel | index | Subcarrier index |
| S-PSS | 1, 2 | {9, 10, 11} + 12 * k, |
| | | {0, 1, . . . , 11} + 12 * k + 12 * (k + 1) * |
| | | i, i = 1, . . . , 10, |
| | | {0, 1, 2, 3} + 12 * k + 12 * (k + 1) * 11 |
| S-SSS | 3, 4 | {9, 10, 11} + 12 * k, |
| | | {0, 1, . . . , 11} + 12 * k + 12 * (k + 1) * |
| | | i, i = 1, . . . , 10, |
| | | {0, 1, 2, 3} + 12 * k + 12 * (k + 1) * 11 |
| Set to zero | 1, 2, 3, 4 | {0, 1, . . . , 8} + 12 * k, |
| | | {4, 5, . . . , 11} + 12 * k + 12 * (k + 1) * |
| | | 11 |
| | 0, 1, 2, . . . , | {0, 1, . . . , 12 * k − 1} + 12 * (k + 1) * |
| | N_{symb}^{S-SSB} − 1 | i, i = 0, 1, . . . , 11 |
| PSBCH | 0, 5, 6, . . . , | {0, 1, . . . , 11} + 12 * k + 12 * (k + 1) * |
| | N_{symb}^{S-SSB} − 1 | i, i = 0, 1, . . . , 11 |
| DM-RS for | 0, 5, 6, . . . , | {0, 4, 8} + 12 * k + 12 * (k + 1) * i, |
| PSBCH | N_{symb}^{S-SSB} − 1 | i = 0, 1, . . . , 11 |

TABLE 5-3
Example resource mapping within a S-SS/PSBCH block.

| Signal or | Symbol | |
|---|---|---|
| channel | index | Subcarrier index |
| S-PSS | 1, 2 | {8, 9, 10, 11}, |
| | | {0, 1, . . . , 11} + 12 * (k + 1) * i, |
| | | i = 1, . . . , 10, |
| | | {0, 1, 2} + 12 * (k + 1) * 11 |
| S-SSS | 3, 4 | {8, 9, 10, 11}, |
| | | {0, 1, . . . , 11} + 12 * (k + 1) * i, |
| | | i = 1, . . . , 10, |
| | | {0, 1, 2} + 12 * (k + 1) * 11 |
| Set to zero | 1, 2, 3, 4 | {0, 1, . . . , 7}, |
| | | {3, 4, . . . , 11} + 12 * (k + 1) * 11 |
| | 0, 1, 2, . . . , | {12, 13, . . . , 12 * (k + 1) − 1} + 12 * |
| | N_{symb}^{S-SSB} − 1 | (k + 1) * i, i = 0, 1, . . . , 11 |
| PSBCH | 0, 5, 6, . . . , | {0, 1, . . . , 11} + 12 * (k + 1) * i, i = 0, |
| | N_{symb}^{S-SSB} − 1 | 1, . . . , 11 |
| DM-RS for | 0, 5, 6, . . . , | {0, 4, 8} + 12 * (k + 1) * i, i = 0, |
| PSBCH | N_{symb}^{S-SSB} − 1 | 1, . . . , 11 |

TABLE 5-4
Example resource mapping within a S-SS/PSBCH block.

| Signal or | Symbol | |
|---|---|---|
| channel | index | Subcarrier index |
| S-PSS | 1, 2 | {9, 10, 11}, |
| | | {0, 1, . . . , 11} + 12 * (k + 1) * i, |
| | | i = 1, . . . , 10, |
| | | {0, 1, 2, 3} + 12 * (k + 1) * 11 |
| S-SSS | 3, 4 | {9, 10, 11}, |
| | | {0, 1, . . . , 11} + 12 * (k + 1) * i, |
| | | i = 1, . . . , 10, |
| | | {0, 1, 2, 3} + 12 * (k + 1) * 11 |
| Set to zero | 1, 2, 3, 4 | {0, 1, . . . , 8} |
| | | {4, 5, . . . , 11} + 12 * (k + 1) * 11 |
| | 0, 1, 2, . . . , | {12, 13, . . . , 12 * (k + 1) − 1} + 12 * |
| | N_{symb}^{S-SSB} − 1 | (k + 1) * i, i = 0, 1, . . . , 11 |
| PSBCH | 0, 5, 6, . . . , | {0, 1, . . . , 11} + 12 * (k + 1) * i, i = 0, |
| | N_{symb}^{S-SSB} − 1 | 1, . . . , 11 |
| DM-RS for | 0, 5, 6, . . . , | {0, 4, 8} + 12 * (k + 1) * i, i = 0, |
| PSBCH | N_{symb}^{S-SSB} − 1 | 1, . . . , 11 |

In another sub-embodiment, the 144 subcarriers within a S-SS/PSBCH block are grouped into 12 RBs (each RB has 12 subcarriers), and further interlaced with k RBs set as zero to construct a block, wherein every two neighboring RBs within the 12 RBs are inserted with k RBs set as zero, and the overall number of RBs of the constructed block is 12+11·k RB in frequency domain (e.g. equivalent to mapping the S-SS/PSBCH block to a set of interlaced RBs with an uniform interval of k RBs between two neighboring RBs, such that the set of interlaced RBs includes RBs with indexes j+(k+1)·i, where j is an index of a first RB in the set of interlaced RBs, and i is the RB index within the set which is an integer starting from 0). Some example resource mappings are shown in TABLE 5-5 (where X=8 or 9), TABLE 5-6, or TABLE 5-7.

TABLE 5-5
Example resource mapping within a S-SS/PSBCH block.

| Signal or | Symbol | |
|---|---|---|
| channel | index | Subcarrier index |
| S-PSS | 1, 2 | {X, . . . , 11}, |
| | | {0, 1, . . . , 11} + 12 * (k + 1) * i, |
| | | i = 1, . . . , 10, |
| | | {0, . . . , 12 − X} + 12 * (k + 1) * 11 |
| S-SSS | 3, 4 | {X, . . . , 11}, |
| | | {0, 1, . . . , 11} + 12 * (k + 1) * i, |
| | | i = 1, . . . , 10, |
| | | {0, . . . , 12 − X} + 12 * (k + 1) * 11 |
| Set to zero | 1, 2, 3, 4 | {0, 1, . . . , X − 1}, |
| | | {13 − X, . . . , 11} + 12 * (k + 1) * 11 |
| | 0, 1, 2, . . . , | {12, 13, . . . , 12 * (k + 1) − 1} + 12 * |
| | N_{symb}^{S-SSB} − 1 | (k + 1) * i, i = 0, 1, . . . , 10 |
| PSBCH | 0, 5, 6, . . . , | {0, 1, . . . , 11} + 12 * (k + 1) * i, |
| | N_{symb}^{S-SSB} − 1 | i = 0, 1, . . . , 11 |
| DM-RS for | 0, 5, 6, . . . , | {0, 4, 8} + 12 * (k + 1) * i, i = 0, |
| PSBCH | N_{symb}^{S-SSB} − 1 | 1, . . . , 11 |

TABLE 5-6
Example resource mapping within a S-SS/PSBCH block.

| Signal or | Symbol | |
|---|---|---|
| channel | index | Subcarrier index |
| S-PSS | 1, 2 | {14, 15, . . . , 23}, |
| | | {0, 1, . . . , 11} + 12 + 12 * (k + 1) * i, |
| | | i = 1, . . . , 9, |
| | | {0, 1, . . . , 8} + 12 + 12 * (k + 1) * 10 |
| S-SSS | 3, 4 | {14, 15, . . . , 23}, |
| | | {0, 1, . . . , 11} + 12 + 12 * (k + 1) * i, |
| | | i = 1, . . . , 9, |
| | | {0, 1, . . . , 8} + 12 + 12 * (k + 1) * 10 |
| Set to zero | 1, 2, 3, 4 | {0, 1, . . . , 13} |
| | | {9, 10, 11} + 12 + 12 * (k + 1) * 10 |
| | 0, 1, 2, . . . , | {12, 13, . . . , 12 * (k + 1) − 1} + 12 * |
| | N_{symb}^{S-SSB} − 1 | (k + 1) * i, i = 0, 1, . . . , 10 |
| PSBCH | 0, 5, 6, . . . , | {0, 1, . . . , 11} + 12 * (k + 1) * i, |
| | N_{symb}^{S-SSB} − 1 | i = 0, 1, . . . , 11 |
| DM-RS for | 0, 5, 6, . . . , | {0, 4, 8} + 12 * (k + 1) * i, |
| PSBCH | N_{symb}^{S-SSB} − 1 | i = 0, 1, . . . , 11 |

TABLE 5-7
Example resource mapping within a S-SS/PSBCH block.

| Signal or | Symbol | |
|---|---|---|
| channel | index | Subcarrier index |
| S-PSS | 1, 2 | {2, 3, . . . , 11}, |
| | | {0, 1, . . . , 11} + 12 * (k + 1) * i, |
| | | i = 1, . . . , 9, |
| | | {0, 1, . . . , 8} + 12 * (k + 1) * 10 |
| S-SSS | 3, 4 | {2, 3, . . . , 11}, |
| | | {0, 1, . . . , 11} + 12 * (k + 1) * i, |
| | | i = 1, . . . , 9, |
| | | {0, 1, . . . , 8} + 12 * (k + 1) * 10 |
| Set to zero | 1, 2, 3, 4 | 0, 1, |
| | | {9, 10, 11} + 12 * (k + 1) * 10 |
| | 0, 1, 2, . . . , | {12, 13, . . . , 12 * (k + 1) − 1} + 12 * |
| | N_{symb}^{S-SSB} − 1 | (k + 1) * i, i = 0, 1, . . . , 10 |
| | | {0, 1, . . . , 11} + 12 + 12 * (k + 1) * 10 |
| PSBCH | 0, 5, 6, . . . , | {0, 1, . . . , 11} + 12 * (k + 1) * i, i = 0, |
| | N_{symb}^{S-SSB} − 1 | 1, . . . , 11 |
| DM-RS for | 0, 5, 6, . . . , | {0, 4, 8} + 12 * (k + 1) * i, i = 0, |
| PSBCH | N_{symb}^{S-SSB} − 1 | 1, . . . , 11 |

In yet another sub-embodiment, the 120 subcarriers within a S-SS/PSBCH block are grouped into 10 RBs (each RB has 12 subcarriers), and further interlaced with k RBs set as zero to construct a block, wherein every two neighboring RBs within the 10 RBs are inserted with k RBs set as zero, and the overall number of RBs of the constructed block is 10+9·k RB in frequency domain (e.g. equivalent to mapping the S-SS/PSBCH block to a set of interlaced RBs with an uniform interval of k RBs between two neighboring RBs, such that the set of interlaced RBs includes RBs with indexes j+(k+1)·i, where j is an index of a first RB in the set of interlaced RBs, and i is the RB index within the set which is an integer starting from 0). Some example resource mappings are shown in TABLE 5-8.

TABLE 5-8
Example resource mapping within a S-SS/PSBCH block.

| Signal or | Symbol | |
|---|---|---|
| channel | index | Subcarrier index |
| S-PSS | 1, 2 | {0, 1, . . . , 11} + 12 * (k + 1) * i, |
| | | i = 0, . . . , 9, |
| S-SSS | 3, 4 | {0, 1, . . . , 11} + 12 * (k + 1) * i, |
| | | i = 0, . . . , 9, |
| Set to zero | 0, 1, 2, . . . , | {12, 13, . . . , 12 * (k + 1) − 1} + 12 * |
| | N_{symb}^{S-SSB} − 1 | (k + 1) * i, i = 0, 1, . . . , 8 |
| PSBCH | 0, 5, 6, . . . , | {0, 1, . . . , 11} + 12 * (k + 1) * i, |
| | N_{symb}^{S-SSB} − 1 | i = 0, 1, . . . , 9 |
| DM-RS for | 0, 5, 6, . . . , | {0, 4, 8} + 12 * (k + 1) * i, i = 0, |
| PSBCH | N_{symb}^{S-SSB} − 1 | 1, . . . , 9 |

In one example, k is a fixed value. For one example, k=1. For another example, k=3. For yet another example, k=7. For yet another example, k=4. For yet another example, k=9.

In another example, k can be determined according to the subcarrier spacing (SCS) of the S-SS/PSBCH block. For one example, k=1 if the SCS of S-SS/PSBCH block is 60 kHz, and/or k=3 if the SCS of S-SS/PSBCH block is 30 kHz, and/or k=7 if the SCS of S-SS/PSBCH block is 15 kHz. For another example, k=0 if the SCS of S-SS/PSBCH block is 60 kHz, and/or k=1 if the SCS of S-SS/PSBCH block is 30 kHz, and/or k=3 if the SCS of S-SS/PSBCH block is 15 kHz. For yet another example, k=1 if the SCS of S-SS/PSBCH block is 60 kHz, and/or k=4 if the SCS of S-SS/PSBCH block is 30 kHz, and/or k=9 if the SCS of S-SS/PSBCH block is 15 kHz.

In yet another example, k can be configured by a RRC parameter. For one example, k can be configured from the set of values {0, 1, 3, 7}. For another example, k can be configured from the set of values {1, 3, 7}. For yet another example, k can be configured from the set of values {0, 1, 3}. For yet another example, k can be configured from the set or its subset of values {0, 1, 2, 3, 4, 5, 6, 7}. For yet another example, k can be configured from the set or its subset of values {0, 1, 2, 3, 4, 5, 6, 7, 8, 9}. For yet another example, k can be configured from the set or its subset of values {1, 4, 9}.

In one sub-embodiment, each subcarrier in the 144 subcarriers within the new S-SS/PSBCH block structure can be interlaced with k subcarriers set as zero to construct a block with 144*(k+1) subcarriers in frequency domain. An illustration of the structure is shown in 801 or 802 of FIG. 8. The example resource mapping is shown in TABLE 6-1, TABLE 6-2, TABLE 6-3, or TABLE 6-4.

TABLE 6-1
Example resource mapping within a S-SS/PSBCH block.

| Signal or | Symbol | |
|---|---|---|
| channel | index | Subcarrier index |
| S-PSS | 1, 2 | k + (k + 1) * i, i = 8, 9, . . . , 134 |
| S-SSS | 3, 4 | k + (k + 1) * i, i = 8, 9, . . . , 134 |
| Set to zero | 1, 2, 3, 4 | k + (k + 1) * i, i = 0, 1, . . . , 7, 135, |
| | | 136, . . . , 143 |
| | 0, 1, 2, . . . , | {0, . . . , k − 1} + (k + 1) * i, i = 0, |
| | N_{symb}^{S-SSB} − 1 | 1, . . . , 143 |
| PSBCH | 0, 5, 6, . . . , | k + (k + 1) * i, i = 0, 1, . . . , 143 |
| | N_{symb}^{S-SSB} − 1 | |
| DM-RS for | 0, 5, 6, . . . , | k + 4 * (k + 1) * i, i = 0, 1, . . . , 35 |
| PSBCH | N_{symb}^{S-SSB} − 1 | |

TABLE 6-2
Example resource mapping within a S-SS/PSBCH block.

| Signal or | Symbol | |
|---|---|---|
| channel | index | Subcarrier index |
| S-PSS | 1, 2 | k + (k + 1) * i, i = 9, 10, . . . , 135 |
| S-SSS | 3, 4 | k + (k + 1) * i, i = 9, 10, . . . , 135 |
| Set to zero | 1, 2, 3, 4 | k + (k + 1) * i, i = 0, 1, . . . , 8, 136, |
| | | 137, . . . , 143 |
| | 0, 1, 2, . . . , | {0, . . . , k − 1} + (k + 1) * i, i = 0, |
| | N_{symb}^{S-SSB} − 1 | 1, . . . , 143 |
| PSBCH | 0, 5, 6, . . . , | k + (k + 1) * i, i = 0, 1, . . . , 143 |
| | N_{symb}^{S-SSB} − 1 | |
| DM-RS for | 0, 5, 6, . . . , | k + 4 * (k + 1) * i, i = 0, 1, . . . , 35 |
| PSBCH | N_{symb}^{S-SSB} − 1 | |

TABLE 6-3
Example resource mapping within a S-SS/PSBCH block.

| Signal or | Symbol | |
|---|---|---|
| channel | index | Subcarrier index |
| S-PSS | 1, 2 | (k + 1) * i, i = 8, 9, . . . , 134 |
| S-SSS | 3, 4 | (k + 1) * i, i = 8, 9, . . . , 134 |
| Set to zero | 1, 2, 3, 4 | (k + 1) * i, i = 0, 1, . . . , 7, 135, |
| | | 136, . . . , 143 |
| | 0, 1, 2, . . . , | {1, . . . , k} + (k + 1) * i, i = 0, |
| | N_{symb}^{S-SSB} − 1 | 1, . . . , 143 |
| PSBCH | 0, 5, 6, . . . , | (k + 1) * i, i = 0, 1, . . . , 143 |
| | N_{symb}^{S-SSB} − 1 | |
| DM-RS for | 0, 5, 6, . . . , | 4 * (k + 1) * i, i = 0, 1, . . . , 35 |
| PSBCH | N_{symb}^{S-SSB} − 1 | |

TABLE 6-4
Example resource mapping within a S-SS/PSBCH block.

| Signal or | Symbol | |
|---|---|---|
| channel | index | Subcarrier index |
| S-PSS | 1, 2 | (k + 1) * i, i = 9, 10, . . . , 135 |
| S-SSS | 3, 4 | (k + 1) * i, i = 9, 10, . . . , 135 |
| Set to zero | 1, 2, 3, 4 | (k + 1) * i, i = 0, 1, . . . , 8, 136, |
| | | 137, . . . , 143 |
| | 0, 1, 2, . . . , | {1, . . . , k} + (k + 1) * i, i = 0, |
| | N_{symb}^{S-SSB} − 1 | 1, . . . , 143 |
| PSBCH | 0, 5, 6, . . . , | (k + 1) * i, i = 0, 1, . . . , 143 |
| | N_{symb}^{S-SSB} − 1 | |
| DM-RS for | 0, 5, 6, . . . , | 4 * (k + 1) * i, i = 0, 1, . . . , 35 |
| PSBCH | N_{symb}^{S-SSB} − 1 | |

In one example, k is a fixed value. For one example, k=1. For another example, k=3. For yet another example, k=7.

In another example, k can be determined according to the subcarrier spacing (SCS) of the S-SS/PSBCH block. For one example, k=1 if the SCS of S-SS/PSBCH block is 60 kHz, and/or k=3 if the SCS of S-SS/PSBCH block is 30 kHz, and/or k=7 if the SCS of S-SS/PSBCH block is 15 kHz. For another example, k=0 if the SCS of S-SS/PSBCH block is 60 kHz, and/or k=1 if the SCS of S-SS/PSBCH block is 30 kHz, and/or k=3 if the SCS of S-SS/PSBCH block is 15 kHz.

In yet another example, k can be configured by a RRC parameter. For one example, k can be configured from the set of values {0, 1, 3, 7}. For another example, k can be configured from the set of values {1, 3, 7}. For yet another example, k can be configured from the set of values {0, 1, 3}. For yet another example, k can be configured from the set or its subset of values {0, 1, 2, 3, 4, 5, 6, 7}.

In one example, the frequency location of the RE with index 66 within the original S-SS/PSBCH block before truncating and mapping to the set of interlaced RBs can be provided by a pre-configuration or configured by a higher layer parameter.

In another example, the index j (e.g. the index of interlace, which defines the frequency location of the interlace) is provided by a pre-configuration or configured by a higher layer parameter.

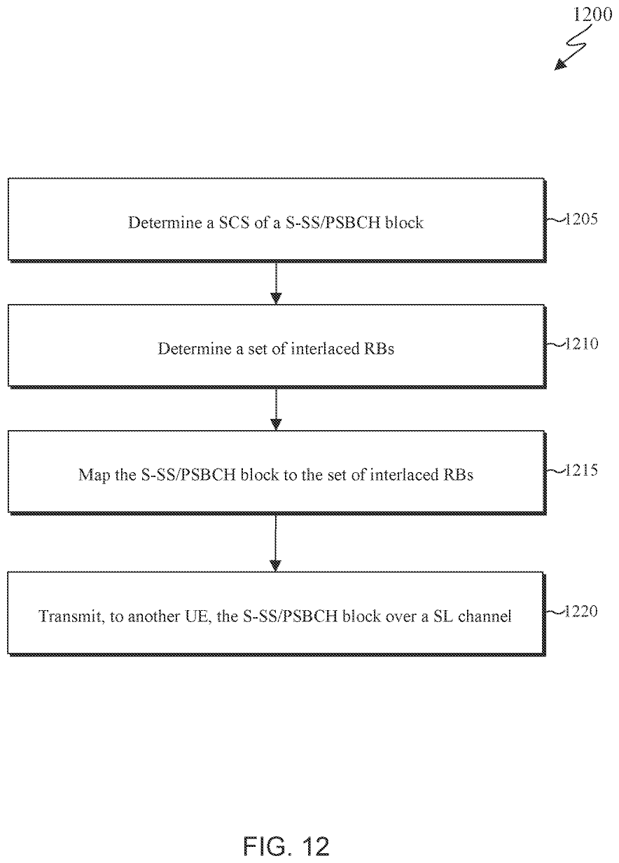

FIG. 12 illustrates a method 1200 for operating with a SS/PSBCH block structure for SL communication according to embodiments of the present disclosure. The steps of the method 1200 of FIG. 12 can be performed by any of the UEs 111-119 of FIG. 1, such as the UE 116 of FIG. 3 and a complementary procedure may be performed by another UE over a SL channel or a BS, e.g., BS 101-103 in FIG. 1. The method 1200 is for illustration only and other embodiments can be used without departing from the scope of the present disclosure.

The method 1200 begins with the UE 111 determining a SCS of a S-SS/PSBCH block (step 1205). For example, in step 1205, the SCS of the S-SS/PSBCH block is (i) determined based on a pre-configuration or a higher-layer parameter and (ii) has value of 15 kHz or 30 kHz.

Thereafter, the UE 111 determines a set of interlaced resource blocks (RBs) (step 1210). For example, in step 1210, the set of interlaced RBs includes RBs with a uniform interval k. The UE 11 may determine the set of interlaced RBs based on pre-configurations or higher-layer parameters. The set of interlaced RBs may include RBs with indexes j+(k+1)·i, where j is an index of a first RB in the set of interlaced RBs, and i is an integer starting from 0. The UE 111 may determine k based on the SCS of the S-SS/PSBCH block. As some examples, k=9, when the SCS of the S-SS/PSBCH block is 15 kHz, and k=4, when the SCS of the S-SS/PSBCH block is 30 kHz.

The UE 111 then maps the S-SS/PSBCH block to the set of interlaced RBs (step 1215). For example, in step 1215, the mapping of the S-SS/PSBCH block to the set of interlaced RBs is based on a number of RBs in the set of interlaced RBs. In one example, the S-SS/PSBCH block includes 132 subcarriers. Here, the 132 subcarriers may be grouped into 11 RBs where each RB of the 11 RBs include 12 subcarriers. In one example, when the number of RBs in the set of interlaced RBs is 11, the S-SS/PSBCH block is mapped to all RBs in the set of interlaced RBs. In another example, when the number of RBs in the set of interlaced RBs is 10, the S-SS/PSBCH block is truncated to 120 subcarriers and mapped to all RBs in the set of interlaced RBs. For example, the S-SS/PSBCH block may be truncated from 132 subcarriers to 120 subcarriers using one of: truncating lowest 12 subcarriers, truncating highest 12 subcarriers or truncating lowest 6 and highest 6 subcarriers.

Thereafter, the UE 111 transmits, to another UE (e.g., UE 111A), the S-SS/PSBCH block over a SL channel (step 1220).

The above flowchart illustrates an example method that can be implemented in accordance with the principles of the present disclosure and various changes could be made to the method illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
determine a subcarrier spacing (SCS) of a sidelink synchronization signals and physical sidelink broadcast channel (S-SS/PSBCH) block;
determine a set of interlaced resource blocks (RBs), wherein the set of interlaced RBs includes RBs with a uniform interval k; and
map the S-SS/PSBCH block to the set of interlaced RBs; and
a transceiver operably coupled to the processor, the transceiver configured to transmit, to another UE, the S-SS/PSBCH block over a sidelink channel.

2. The UE of claim 1, wherein the set of interlaced RBs are determined based on pre-configurations or higher-layer parameters.

3. The UE of claim 1, wherein the set of interlaced RBs includes RBs with indexes j+(k+1)·i, where j is an index of a first RB in the set of interlaced RBs, and i is an integer starting from 0.

4. The UE of claim 1, wherein the SCS of the S-SS/PSBCH block is (i) determined based on a pre-configuration or a higher-layer parameter and (ii) has a value of 15 kHz or 30 kHz.

5. The UE of claim 1, wherein:
k is determined based on the SCS of the S-SS/PSBCH block,
k=9, when the SCS of the S-SS/PSBCH block is 15 kHz, and
k=4, when the SCS of the S-SS/PSBCH block is 30 kHz.

6. The UE of claim 1, wherein:
the S-SS/PSBCH block includes 132 subcarriers,
the 132 subcarriers are grouped into 11 RBs, and
each RB of the 11 RBs includes 12 subcarriers.

7. The UE of claim 1, wherein the mapping of the S-SS/PSBCH block to the set of interlaced RBs is based on a number of RBs in the set of interlaced RBs.

8. The UE of claim 7, wherein when the number of RBs in the set of interlaced RBs is 11, the S-SS/PSBCH block is mapped to all RBs in the set of interlaced RBs.

9. The UE of claim 7, wherein when the number of RBs in the set of interlaced RBs is 10, the S-SS/PSBCH block is truncated to 120 subcarriers and mapped to all RBs in the set of interlaced RBs.

10. The UE of claim 9, wherein the S-SS/PSBCH block is truncated from 132 subcarriers to 120 subcarriers using one of:
truncating lowest 12 subcarriers;
truncating highest 12 subcarriers; or
truncating lowest 6 and highest 6 subcarriers.

11. A method of a user equipment (UE) in a wireless communication system, the method comprising:
determining a subcarrier spacing (SCS) of a sidelink synchronization signals and physical sidelink broadcast channel (S-SS/PSBCH) block;
determining a set of interlaced resource blocks (RBs), wherein the set of interlaced RBs includes RBs with a uniform interval k;
mapping the S-SS/PSBCH block to the set of interlaced RBs; and
transmitting, to another UE, the S-SS/PSBCH block over a sidelink channel.

12. The method of claim 11, wherein the set of interlaced RBs are determined based on pre-configurations or higher-layer parameters.

13. The method of claim 11, wherein the set of interlaced RBs includes RBs with indexes j+(k+1)·i, where j is an index of a first RB in the set of interlaced RBs, and i is an integer starting from 0.

14. The method of claim 11, wherein the SCS of the S-SS/PSBCH block is (i) determined based on a pre-configuration or a higher-layer parameter and (ii) has value of 15 kHz or 30 kHz.

15. The method of claim 11, wherein:
k is determined based on the SCS of the S-SS/PSBCH block,
k=9, when the SCS of the S-SS/PSBCH block is 15 kHz, and
k=4, when the SCS of the S-SS/PSBCH block is 30 kHz.

16. The method of claim 11, wherein:
the S-SS/PSBCH block includes 132 subcarriers,
the 132 subcarriers are grouped into 11 RBs, and
each RB of the 11 RBs include 12 subcarriers.

17. The method of claim 11, wherein the mapping of the S-SS/PSBCH block to the set of interlaced RBs is based on a number of RBs in the set of interlaced RBs.

18. The method of claim 17, wherein when the number of RBs in the set of interlaced RBs is 11, the S-SS/PSBCH block is mapped to all RBs in the set of interlaced RBs.

19. The method of claim 17, wherein when the number of RBs in the set of interlaced RBs is 10, the S-SS/PSBCH block is truncated to 120 subcarriers and mapped to all RBs in the set of interlaced RBs.

20. The method of claim 19, wherein the S-SS/PSBCH block is truncated from 132 subcarriers to 120 subcarriers using one of:
truncating lowest 12 subcarriers;
truncating highest 12 subcarriers; or
truncating lowest 6 and highest 6 subcarriers.
